(19) United States
(12) Patent Application Publication
(10) Pub. No.: US 2022/0179890 A1
(43) Pub. Date: Jun. 9, 2022

(54) INFORMATION PROCESSING APPARATUS, NON-TRANSITORY COMPUTER-READABLE STORAGE MEDIUM, AND INFORMATION PROCESSING METHOD

(71) Applicant: Mitsubishi Electric Corporation, Tokyo (JP)

(72) Inventor: Hideaki JOKO, Tokyo (JP)

(73) Assignee: Mitsubishi Electric Corporation, Tokyo (JP)

(21) Appl. No.: 17/676,963

(22) Filed: Feb. 22, 2022

Related U.S. Application Data
(63) Continuation of application No. PCT/JP2019/034632, filed on Sep. 3, 2019.

(51) Int. Cl. G06F 16/33; G06F 16/35; G06F 40/284

(52) U.S. Cl. CPC G06F 16/3344; G06F 40/284; G06F 16/35

(57) ABSTRACT

An information processing apparatus includes a processor to execute a program; and a memory to store multiple retrieval target sentences including multiple retrieval target tokens and similarity determination information indicating whether combinations of the respective retrieval target tokens and respective retrieval tokens have high similarity or low similarity, the retrieval target tokens each being a smallest unit having a meaning, the retrieval tokens each being a smallest unit having a meaning and being included in a retrieval sentence. The memory stores the program which, when executed by the processor, performs processes of calculating inter-token similarity for the combinations indicated to have high similarity in the similarity determination information, and setting the inter-token similarity to a predetermined value for the combinations indicated to have low similarity in the similarity determination information, to calculate inter-sentence similarity between the retrieval sentence and the respective retrieval target sentences.

### CROSS-REFERENCE TO RELATED APPLICATION

This application is a continuation application of International Application No. PCT/JP2019/034632 having an international filing date of Sep. 3, 2019.

### BACKGROUND OF THE INVENTION

### 1. Field of the Invention

The present invention relates to an information processing apparatus, a non-transitory computer-readable storage medium, and an information processing method.

### 2. Description of the Related Art

The wide use of personal computers and the Internet has led to an increase in the volume of electronic documents accessible by users. There is a need for an efficient document retrieval technique for finding desired documents in such a large volume of documents.

In order to process the meaning of a natural language in document retrieval, it is useful to represent tokens, which are each a smallest unit of a character or a character string having a meaning, by vectors indicating the meanings of the corresponding tokens.

A method of giving one vector to one token is a mainstream technique; however, such a technique cannot eliminate the ambiguity in the meaning of a token having multiple meanings depending on context. Therefore, a technique is proposed for acquiring a vector of a token that allows the context to be considered.

In document retrieval, it is necessary to measure with high accuracy the similarity in meaning between a retrieval query that is a retrieval sentence input for retrieval and a retrieval target sentence that is a target of retrieval. In measuring the similarity with high accuracy, it is useful to calculate the inter-token similarity between tokens of the retrieval query and the retrieval target sentence.

For example, Non-patent Literature 1 describes a method of calculating the inter-sentence similarity by selecting the tokens having the highest similarity to tokens xᵢ included in a retrieval query x from tokens Yⱼₖ included in retrieval target sentences Yⱼ, and using a value obtained by averaging the inter-token similarities φ(xᵢ,Yⱼₖ) calculated for the combinations of the i words.

Non-patent Literature: Tomoyuki Kajiwara and Mamoru Komachi, “Text Simplification without Simplified Corpora,” Journal of Natural Language Processing, 25(2), pp. 223-249, 2018.

### SUMMARY OF THE INVENTION

In calculating the inter-sentence similarity, it is necessary to calculate the similarity in all combinations of all tokens included in the retrieval query and all tokens included in the retrieval target sentences, and this results in an enormous amount of calculation, which makes practical application difficult.

For example, when one vector representation is given to one token, every similarity between the tokens can be preliminarily calculated and stored as data in a lookup table or the like so that the calculation of similarity can be omitted at the time of retrieval. However, when vector representations of tokens that allow the context in which the tokens appear to be considered are used, the meaning of each token varies depending on the context, and thus the similarity between the tokens cannot be calculated in advance.

Accordingly, an object of at least one aspect of the invention is to reduce the load of calculating similarities for document retrieval.

An information processing apparatus according to an aspect of the invention includes a retrieval-target storage unit configured to store multiple retrieval target sentences including multiple retrieval target tokens, the retrieval target tokens each being a smallest unit having a meaning; a similarity-determination-information storage unit configured to store similarity determination information indicating whether combinations of the respective retrieval target tokens and respective retrieval tokens have high similarity or low similarity, the retrieval tokens each being a smallest unit having a meaning and being included in a retrieval sentence; and an inter-sentence-similarity calculation unit configured to calculate inter-token similarity for the combinations indicated to have high similarity in the similarity determination information, and sets the inter-token similarity to a predetermined value for the combinations indicated to have low similarity in the similarity determination information, to calculate inter-sentence similarity between the retrieval sentence and the respective retrieval target sentences.

A program according to an aspect of the invention causes a computer to function as a retrieval-target storage unit configured to store multiple retrieval target sentences including multiple retrieval target tokens, the retrieval target tokens each being a smallest unit having a meaning; a similarity-determination-information storage unit configured to store similarity determination information indicating whether combinations of the respective retrieval target tokens and respective retrieval tokens have high similarity or low similarity, the retrieval tokens each being a smallest unit having a meaning and being included in a retrieval sentence; and an inter-sentence-similarity calculation unit configured to calculate inter-token similarity for the combinations indicated to have high similarity in the similarity determination information, and sets the inter-token similarity to a predetermined value for the combinations indicated to have low similarity in the similarity determination information, to calculate inter-sentence similarity between the retrieval sentence and the respective retrieval target sentences.

An information processing method includes calculating inter-sentence similarities between multiple retrieval target sentences including multiple retrieval target tokens and a retrieval sentence including multiple retrieval tokens, the retrieval target tokens each being a smallest unit having a meaning, the retrieval tokens each being a smallest unit having a meaning; calculating inter-token similarity for combinations indicated to have high similarity in the similarity determination information indicating whether the combinations of the retrieval target tokens and the retrieval tokens have high similarity or low similarity, and sets the inter-token similarity to a predetermined value for the combinations indicated to have low similarity in the similarity determination information, to calculate the inter-sentence similarities between the retrieval sentence and the respective retrieval target sentences.

According to at least one aspect of the present invention, the load of calculating similarity for document retrieval can be reduced.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating the configuration of a document retrieval apparatus or information processing apparatus according to a first embodiment;

FIG. 2 is a schematic diagram illustrating an example of a retrieval-target token sequence;

FIG. 3 is a schematic diagram illustrating an example of a retrieval-target context-sensitive representation sequence;

FIG. 4 is a schematic diagram illustrating an example of a retrieval-query token sequence;

FIG. 5 is a schematic diagram illustrating an example of a retrieval-query context-sensitive representation sequence;

FIG. 6 is a schematic diagram illustrating an example of a similar token table;

FIG. 7 is a block diagram schematically illustrating the hardware configuration for implementing a document retrieval apparatus;

FIG. 8 is a flowchart illustrating processing by a retrieval-target context-sensitive representation generating unit according to the first embodiment;

FIG. 9 is a flowchart illustrating processing by a data structure converting unit;

FIG. 10 is a flowchart illustrating processing by a tokenizer;

FIG. 11 is a flowchart illustrating processing by a retrieval-query context-sensitive representation generating unit;

FIG. 12 is a flowchart illustrating processing by a similar-token-table generating unit;

FIG. 13 is a flowchart illustrating processing by an inter-sentence-similarity calculation unit;

FIG. 14 is a flowchart illustrating processing by a retrieval-result output unit;

FIG. 15 is a block diagram schematically illustrating the configuration of a document retrieval apparatus or information processing apparatus according to a second embodiment;

FIG. 16 is a flowchart illustrating processing by a retrieval-target context-sensitive representation generating unit according to the second embodiment;

FIG. 17 is a block diagram schematically illustrating the configuration of a document retrieval apparatus or information processing apparatus according to a third embodiment;

FIG. 18 is a flowchart illustrating processing by a retrieval-target dimension reducing unit; and

FIG. 19 is a flowchart illustrating processing by a retrieval-query dimension reducing unit.

### DETAILED DESCRIPTION OF THE INVENTION

### First Embodiment

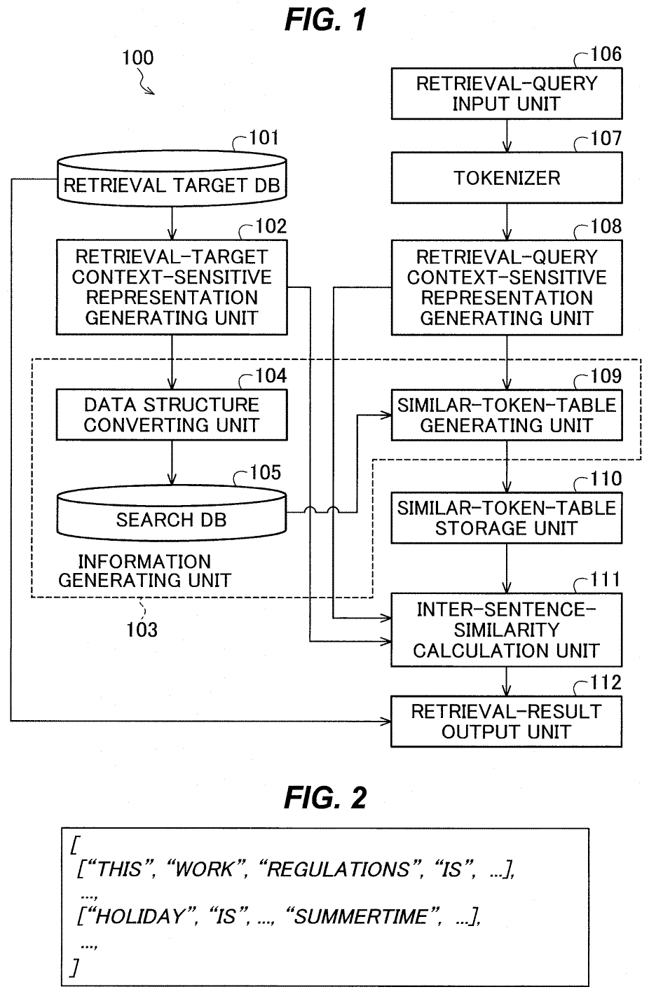

FIG. 1 is a block diagram schematically illustrating the configuration of a document retrieval apparatus 100, or information processing apparatus according to the first embodiment.

The document retrieval apparatus 100 includes a retrieval target database (hereinafter referred to as a retrieval target DB) 101, a retrieval-target context-sensitive representation generating unit 102, an information generating unit 103, a retrieval-query input unit 106, a tokenizer 107, a retrieval-query context-sensitive representation generating unit 108, a similar-token-table storage unit 110, an inter-sentence-similarity calculation unit 111, and a retrieval-result output unit 112.

The information generating unit 103 includes a data structure converting unit 104, a search database (hereinafter referred to as a search DB) 105, and a similar-token-table generating unit 109.

The retrieval target DB 101 is a retrieval-target storage unit that stores retrieval target sentences and retrieval-target token sequences corresponding to the retrieval target sentences. The retrieval-target token sequence is a sequence of multiple tokens, and one retrieval-target token sequence constitutes one sentence. Note that a token is a smallest unit having a meaning and is a character or a character string. The tokens included in a retrieval-target token sequence are also referred to as retrieval target tokens. It is presumed that the retrieval target DB 101 stores multiple retrieval target sentences and multiple retrieval-target token sequences corresponding to the retrieval target sentences.

In the following, a document retrieval task of retrieving an article corresponding to a retrieval query is considered as an example. Specifically, a task is considered in which the article “Holidays are as follows: summertime holiday . . . ” corresponding to the retrieval query “When does summer vacation start and end?” is retrieved from multiple articles. Here, the multiple articles are the multiple retrieval target sentences.

In such a case, the retrieval-target token sequence may be in a two-dimensional sequence format, as illustrated in FIG. 2. In the example of the retrieval-target token sequence illustrated in FIG. 2, the p-th article is stored in the p-th row, and the q-th retrieval target token counted from the beginning of the p-th article is stored in the p-th row and q-th column. In FIG. 2, a retrieval target token is a character or a character string surrounded by double quotations.

The retrieval-target context-sensitive representation generating unit 102 acquires retrieval-target token sequences from the retrieval target DB 101. The retrieval-target context-sensitive representation generating unit 102 then generates a retrieval-target context-sensitive representation sequence in which retrieval-target context-sensitive representations, which are the context-sensitive representations of all retrieval target tokens included in the acquired retrieval-target token sequences, are arrayed. The generated retrieval-target context-sensitive representation sequence is provided to the data structure converting unit 104 and the inter-sentence-similarity calculation unit 111. Here, the context-sensitive representations are vectors, and the retrieval-target context-sensitive representations are retrieval target vectors.

For example, the retrieval-target context-sensitive representation generating unit 102 is a retrieval-target-vector generating unit that generates retrieval target vectors, or vectors corresponding to the meanings of the retrieval target tokens included in retrieval-target token sequences. Here, the retrieval-target context-sensitive representation generating unit 102 identifies the meanings of the retrieval target tokens depending on the context of the retrieval target sentences corresponding to retrieval-target token sequences including the retrieval target tokens, and generates retrieval target vectors indicating the determined meanings.

Specifically, the retrieval-target context-sensitive representation generating unit 102 identifies the meanings depending on the context of the respective retrieval target tokens included in the retrieval-target token sequences. The retrieval-target context-sensitive representation generating unit 102 then arrays multidimensional vectors indicating the determined meanings in accordance with the respective sequences of the retrieval target tokens to generate the retrieval-target context-sensitive representation sequence.

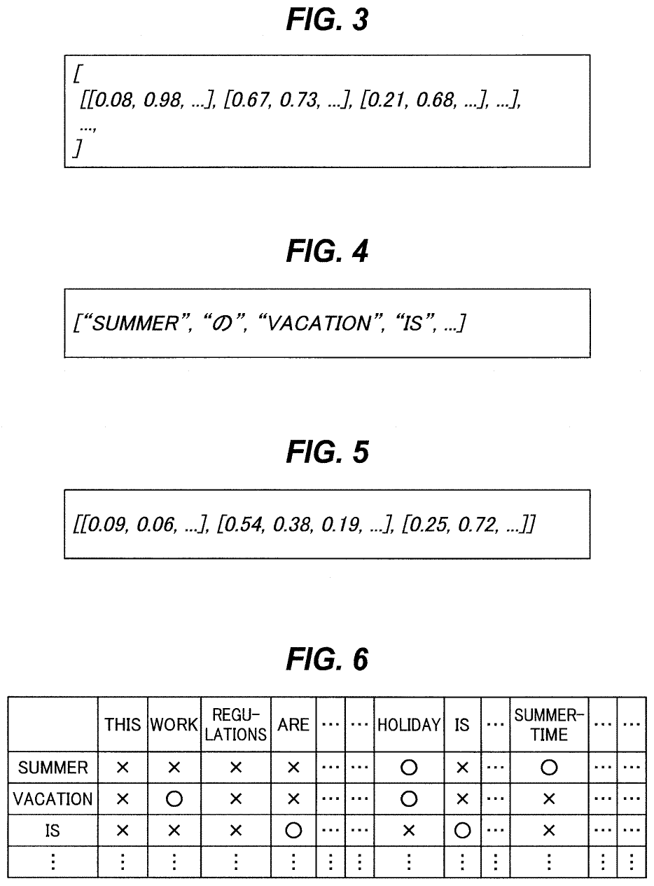

The retrieval-target context-sensitive representation sequence may be in a two-dimensional sequence format, for example, as illustrated in FIG. 3. In the retrieval-target context-sensitive representation sequence illustrated in FIG. 3, the p-th piece of text is stored in the p-th row, and a vector, or context-sensitive representation, corresponding to the q-th retrieval target token counted from the beginning of the p-th article is stored in the p-th row and q-th column.

Note that a known method may be used for identifying the context-sensitive representations corresponding to the retrieval target tokens. For example, the following literature describes a method of acquiring a vector representation of a token that allows the context in which the token appears to be considered.

Jacob Devlin, Ming-Wei Chang, Kenton Lee, and Kristina Toutanova, “BERT: Pre-training of Deep Bidirectional Transformers for Language Understanding,” CoRR, abs/1810. 04805. May 24, 2018.

The data structure converting unit 104 acquires the retrieval-target context-sensitive representation sequence from the retrieval-target context-sensitive representation generating unit 102. The data structure converting unit 104 then converts the acquired retrieval-target context-sensitive representation sequence into a search data structure. The generated search data structure is stored in the search DB 105.

The search data structure may be selected from any known data structure in accordance with the algorithm of the k-approximate nearest neighbor search to be used. For example, when approximate nearest neighbor search (ANN) is used as the algorithm for the k-approximate nearest neighbor search, a data structure of a k-d tree may be selected. If locality sensitive hashing (LSH) is used as the algorithm of the k-approximate nearest neighbor search, the mapping results by a hash function may be selected as the data structure. Here, an example will be described in which ANN is used as the algorithm of the k-approximate nearest neighbor search, and the data structure of a k-d tree is used as the search data structure.

Note that these algorithms are described in the following literature.

Toshikazu Wada, “Nearest Neighbor Search Theory and Algorithm,” IPSJ SIG technical report, No. 13, 2009.

The search DB 105 stores the search data structure converted by the data structure converting unit 104.

The retrieval-query input unit 106 is a retrieval input unit that accepts input of a retrieval query, or retrieval sentence. The retrieval query includes multiple tokens. The tokens included in the retrieval query are also referred to as retrieval tokens.

For example, the retrieval-query input unit 106 accepts input of a question such as “When does the summer vacation start and end?” as a retrieval query.

The tokenizer 107 acquires the retrieval query from the retrieval-query input unit 106. The tokenizer 107 is a token identifying unit that identifies retrieval query tokens in the acquired retrieval query and generates a retrieval-query token sequence in which the retrieval query tokens are arrayed. The generated retrieval-query token sequence is provided to the retrieval-query context-sensitive representation generating unit 108. Note that the tokens included in the retrieval-query token sequence are also referred to as retrieval query tokens.

For example, the tokenizer 107 uses any known technique such as morphological analysis to identify tokens, which are the smallest units having meanings, in the retrieval query and arrays the identified tokens to generate a retrieval-query token sequence.

FIG. 4 is a schematic diagram illustrating an example of a retrieval-query token sequence.

In the example illustrated in FIG. 4, the r-th token of the retrieval query is stored as the r-th element of the retrieval-query token sequence.

The retrieval-query context-sensitive representation generating unit 108 acquires the retrieval-query token sequence from the tokenizer 107. The retrieval-query context-sensitive representation generating unit 108 then generates a retrieval-query context-sensitive representation sequence including arrayed retrieval-query context-sensitive representations, which are context-sensitive representations of retrieval query tokens, or all tokens included in the acquired retrieval-query token sequence. The generated retrieval-query context-sensitive representation sequence is provided to the similar-token-table generating unit 109 and the inter-sentence-similarity calculation unit 111. Here, the retrieval-query context-sensitive representations are retrieval vectors.

For example, the retrieval-query context-sensitive representation generating unit 108 is a retrieval-vector generating unit that generates retrieval vectors, or vectors corresponding to the meanings of the retrieval tokens. Here, the retrieval-query context-sensitive representation generating unit 108 identifies the meanings of the retrieval tokens depending on the context of the retrieval sentence and generates retrieval vectors indicating the identified meanings.

Specifically, the retrieval-query context-sensitive representation generating unit 108 identifies the meanings depending on the context of the respective retrieval query tokens included in the retrieval-query token sequence. The retrieval-query context-sensitive representation generating unit 108 can array multidimensional vectors indicating the identified meanings in accordance with the sequence of the respective retrieval query tokens to generate a retrieval-query context-sensitive representation sequence. Note that a known method may be used for identifying the context-sensitive representations corresponding to the retrieval query tokens, as in the retrieval-target context-sensitive representations described above.

FIG. 5 is a schematic diagram illustrating an example of a retrieval-query context-sensitive representation sequence.

In the example illustrated in FIG. 5, a vector, or context-sensitive representation corresponding to the r-th token of the retrieval query is stored as the r-th element of the retrieval-query context-sensitive representation sequence.

The similar-token-table generating unit 109 acquires the retrieval-query context-sensitive representation sequence from the retrieval-query context-sensitive representation generating unit 108 and acquires the search data structure from the search DB 105. The similar-token-table generating unit 109 generates a similar token table serving as similarity determination information indicating whether the similarity of each combination of a retrieval target token and a retrieval query token is relatively high or low, from the acquired retrieval-query context-sensitive representation sequence and search data structure. The generated similar token table is stored in the similar-token-table storage unit 110.

For example, the similar-token-table generating unit 109 may determine whether the similarity is relatively high or low for the respective combinations of the retrieval target tokens and the retrieval query tokens through a known search method that is more efficient than a brute-force search in which the similarity for all combinations of the retrieval target tokens and the retrieval query tokens is calculated to use the calculated similarity for determining whether the similarity is relatively high or not. For example, the similar-token-table generating unit 109 may search for k retrieval target tokens having high similarity relative to a certain retrieval query token by using the k-approximate nearest neighbor search to search for k neighboring points (where k is an integer of one or more). The similar-token-table generating unit 109 may set the k searched tokens to be tokens having relatively high similarity and set the remaining retrieval target tokens to be tokens having relatively low similarity. Note that a known technique such as ANN or LSH may be used as the algorithm of the k-approximate nearest neighbor search.

FIG. 6 is a schematic diagram illustrating an example of a similar token table.

The example illustrated in FIG. 6 is a lookup table showing that when the above-mentioned retrieval query “summer vacation is . . . ” is input, the similarity between each token included in the retrieval query and each token included in all retrieval target sentences is relatively high or low in the retrieval target sentences.

In the example illustrated in FIG. 6, the rows represent retrieval query tokens, and the columns represent retrieval target tokens. The circle symbol indicates that the similarity is relatively high, and the cross symbol indicates that the similarity is relatively low. For example, for the retrieval query token “summer,” the similarity to the retrieval target tokens “holiday” and “summertime” are relatively high in the tokens included in all of the retrieval target sentences.

Since the k-approximate nearest neighbor search algorithm can be applied to the generation of the similar token table, there is an advantage in that the calculation amount can be reduced.

In FIG. 6, for ease of explanation, retrieval query tokens are stored in the rows, and retrieval target tokens are stored in the columns; however, here, retrieval context-sensitive representations (i.e., retrieval vectors) corresponding to retrieval query tokens are stored in the rows, and retrieval-target context-sensitive representations (i.e., retrieval target vectors) corresponding to the retrieval target tokens are stored in the columns.

As described above, the data structure converting unit 104, the search DB 105, and the similar-token-table generating unit 109 constitute the information generating unit 103 that generates a similar token table, or similarity determination information.

The information generating unit 103 searches the multiple points indicated by multiple retrieval target vectors for at least one neighboring point located in the vicinity of one point indicated by one retrieval vector of the multiple retrieval vectors, determines that the at least one combination of the retrieval token corresponding to the point indicated by the one retrieval vector and the at least one retrieval target token corresponding to the at least one neighboring point has high similarity, and determines that the at least one combination of the one retrieval token and the at least one retrieval target token corresponding to the at least one point other than the at least one neighboring point has low similarity, to generate a similar token table. Here, the information generating unit 103 searches for at least one neighboring point by using a search method more efficient than a brute-force search for calculating all distances between the point corresponding to one retrieval vector and multiple points corresponding to multiple retrieval target vectors.

The similar-token-table storage unit 110 is a similarity-determination-information storage unit for storing a similar token table serving as similarity determination information.

The similar token table indicates whether combinations of retrieval target tokens and retrieval tokens have high or low similarity.

The inter-sentence-similarity calculation unit 111 acquires the similar token table from the similar-token-table storage unit 110, acquires the retrieval-target context-sensitive representation sequence from the retrieval-target context-sensitive representation generating unit 102, and acquires the retrieval-query context-sensitive representation sequence from the retrieval-query context-sensitive representation generating unit 108. The inter-sentence-similarity calculation unit 111 calculates the inter-sentence similarity, or the similarity between the retrieval query and the retrieval target sentences from the acquired similar token table, retrieval-target context-sensitive representation sequence, and retrieval-query context-sensitive representation sequence. The calculated inter-sentence similarity is provided to the retrieval-result output unit 112.

Here, the inter-sentence-similarity calculation unit 111 calculates the inter-token similarity of the combinations that are indicated to have high similarity in the similar token table, and sets the inter-token similarity to a predetermined value for the combinations that are indicated to have low similarity in the similar token table, thereby reducing the calculation load for the calculation of the inter-sentence similarity. Note that when the inter-sentence-similarity calculation unit 111 calculates the inter-token similarity, the inter-token similarity is set such that the smaller the distance between a point indicated by one retrieval target vector of multiple retrieval target vectors and a point indicated by one retrieval vector of multiple retrieval vectors, the higher the similarity of the combination of the retrieval target vector and the retrieval vector. The inter-sentence-similarity calculation unit 111 then identifies the maximum values of the inter-token similarity in the combinations of the respective retrieval tokens and the respective retrieval target tokens included in one of the multiple retrieval target sentences, and calculates the inter-sentence similarity between the retrieval sentence and the one retrieval target sentence on the basis of the average of the identified maximum values.

The calculation of the inter-sentence similarity will now be explained.

The inter-sentence similarity may be calculated by using any inter-token similarity. For example, the inter-sentence similarity may be calculated by using the maximum alignment method described in the above-mentioned Non-patent Literature 1.

First, the calculation of inter-sentence similarity by a general maximum alignment method will be described, and then accelerated calculation of the inter-sentence similarity according to the first embodiment will be described.

In the calculation of the inter-sentence similarity by the general maximum alignment method, the token having the highest inter-token similarity to each retrieval query token xᵢ included in a retrieval query x is selected from retrieval target tokens Y, included in a retrieval target sentence Yⱼ. Then, the inter-sentence similarity is calculated by the average value obtained by averaging the inter-token similarities φ(xᵢ,Yⱼₖ) calculated for the selected i=|x| retrieval target tokens.

The calculation of the inter-sentence similarity by a maximum alignment method is formulated as in the following expression (1), where the inter-sentence similarity between a retrieval query x and the j-th retrieval target sentence Yⱼ is s(x,Yⱼ).

$$\begin{matrix}[ Expression 1 ] & \\ s ( x , {Y}_{j} ) = \frac{1}{\vert x \vert} {\sum }_{i = 1}^{\vert x \vert} {max}_{k} ϕ ( {x}_{i} , {Y}_{jk} ) & ( 1 )\end{matrix}$$

Here, xᵢ denotes the i-th retrieval query token of the retrieval query x, Yⱼ denotes the k-th retrieval target token of the retrieval target sentence Yⱼ, and p(xᵢ,Yⱼₖ) denotes the inter-token similarity between the retrieval query token xᵢ and the retrieval target token Yⱼₖ. For inter-token similarity, the distance (e.g., the cosine similarity of a context-sensitive representation) between the vector of a retrieval query token and the vector of a retrieval target token is used.

In the maximum alignment method, the inter-sentence similarity between a retrieval query and each retrieval target sentence is calculated on the basis of the above concept.

This corresponds to obtaining the inter-sentence similarity s between the retrieval query and all of the retrieval target sentences and generating the inter-sentence similarity S(x,Y) between the retrieval query and each retrieval target sentence, as indicated in the following expression (2).

$$\begin{matrix}[ Expression 2 ] & \\ S ( x , Y ) = [ \begin{matrix}s ( x , {Y}_{1} ) \\ . . . \\ s ( x , {Y}_{j} ) \\ . . .\end{matrix} ] & ( 2 )\end{matrix}$$

Here, the j-th element of S(x,Y) is the inter-sentence similarity between the retrieval query x and the retrieval target sentence Yⱼ.

Next, the expression of the above-mentioned maximum alignment method is modified.

A similarity matrix A(i) consisting of a retrieval query token xᵢ and all retrieval target tokens is defined by the following expression (3).

$$\begin{matrix}[ Expression 3 ] & \\ A ( i ) = [ \begin{matrix}ϕ ( {x}_{i} , {Y}_{11} ) & . . . & ϕ ( {x}_{i} , {Y}_{1 \vert {Y}_{1} \vert} ) & 0 & 0 \\ . . . & . . . & . . . & . . . & . . . \\ ϕ ( {x}_{i} , {Y}_{j 1} ) & . . . & ϕ ( {x}_{i} , {Y}_{jk} ) . . . & . . . & . . . \\ . . . & . . . & . . . & . . . & . . .\end{matrix} ] & ( 3 )\end{matrix}$$

Here, the similarity matrix A(i) is a matrix of the type indicated by the following expression (4).

$$\begin{matrix}[ Expression 4 ] & \\ \vert Y \vert \times {max}_{j} ( \vert {Y}_{j} \vert ) & ( 4 )\end{matrix}$$

Note that |Y| denotes the total number of retrieval target sentences, and |Yⱼ| denotes the number of retrieval target tokens included in the j-th retrieval target sentence.

Note that for the row l satisfying the following expression (5), the inter-token similarity p cannot be calculated because no retrieval target tokens correspond to the (|Yₗ|+1)-th and subsequent rows. Therefore, zero-padding processing may be performed to fill the inter-token similarity with zero.

$$\begin{matrix}[ Expression 5 ] & \\ \vert {Y}_{i} \vert < {max}_{j} ( \vert {Y}_{j} \vert ) & ( 5 )\end{matrix}$$

The maximum value max of the similarity then is defined by the following expression (6).

$$\begin{matrix}[ Expression 6 ] & \\ max A ( i ) = [ \begin{matrix}{max}_{k} {A ( i )}_{1 k} \\ . . . \\ {max}_{k} {A ( i )}_{jk} \\ . . .\end{matrix} ] & ( 6 )\end{matrix}$$

In such a case, the inter-sentence similarity S(x,Y) between the retrieval query and each retrieval target sentence can be modified as in the following expression (7).

$$\begin{matrix}[ Expression 7 ] & \\ \begin{matrix}S ( x , Y ) = [ \begin{matrix}s ( x , {Y}_{1} ) \\ . . . \\ s ( x , {Y}_{j} ) \\ . . .\end{matrix} ] \\ = [ \begin{matrix}\frac{1}{\vert x \vert} {\sum }_{i = 1}^{\vert x \vert} {max}_{k} ϕ ( {x}_{i} , {Y}_{1 k} ) \\ . . . \\ \frac{1}{\vert x \vert} {\sum }_{i = 1}^{\vert x \vert} {max}_{k} ϕ ( {x}_{i} , {Y}_{jk} ) \\ . . .\end{matrix} ] \\ = \frac{1}{\vert x \vert} {\sum }_{i = 1}^{\vert x \vert} {max}_{k} [ \begin{matrix}ϕ ( {x}_{i} , {Y}_{1 k} ) \\ . . . \\ ϕ ( {x}_{i} , {Y}_{jk} ) \\ . . .\end{matrix} ] \\ = \frac{1}{\vert x \vert} {\sum }_{i = 1}^{\vert x \vert} max A ( i )\end{matrix} & ( 7 )\end{matrix}$$

As indicated by the expression (7), it is necessary to obtain the similarity matrix A(i) to obtain the inter-sentence similarity S(x,Y) between the retrieval query x and each retrieval target sentence Y.

However, the calculation amount for obtaining the similarity matrix A(i) is O(|x|Σⱼ|Yⱼ|). Therefore, there has been a problem in that when the volume of the retrieval target sentences is large, the calculation amount of Σⱼ|Yⱼ| is enormous, which is not a practical calculation amount.

Accordingly, the inter-sentence-similarity calculation unit 111 according to the first embodiment speeds up the calculation of the inter-sentence similarity.

In the maximum alignment method before the speed-up, the values of the inter-token similarity between the retrieval query tokens and all of the retrieval target tokens are compared relatively for each retrieval target sentence, and the maximum values are acquired, to acquire the maximum value max of the inter-token similarity between a retrieval query token xᵢ and a retrieval target sentence Yⱼ as indicated by the expression (6).

However, in the document retrieval task, if a value of inter-token similarity is relatively high in one retrieval target sentence but relatively low in all retrieval target sentences, the possibility of this inter-token similarity affecting the inter-document similarity is low.

Accordingly, when the inter-token similarity is relatively low in all retrieval target sentences, the inter-sentence-similarity calculation unit 111 skips the calculation of this inter-token similarity (for example, approximates it to zero) to speed up the calculation of the inter-document similarity.

Specifically, the inter-sentence-similarity calculation unit 111 approximates the similarity matrix A(i) as indicated by the following expression (8).

$$\begin{matrix}[ Expression 8 ] & \\ A \approx \hat{A} = [ \begin{matrix}γ ( {x}_{i} , {Y}_{11} ) & . . . & γ ( {x}_{i} , {Y}_{1 k} ) & 0 & 0 \\ . . . & . . . & . . . & . . . & . . . \\ γ ( {x}_{i} , {Y}_{j 1} ) & . . . & . . . & . . . & . . .\end{matrix} ] & ( 8 )\end{matrix}$$

where γ(xᵢ,Yⱼₖ) is specified by the following expression (9).

$$\begin{matrix}[ Expression 9 ] & \\ γ ( {x}_{i} , {Y}_{jk} ) = \{ \begin{matrix}ϕ ( {x}_{i} , {Y}_{jk} ) & if {Y}_{jk} ∈ Simset ( {x}_{i} ) \\ 0 & otherwise\end{matrix} & ( 9 )\end{matrix}$$

Here, Simset(xᵢ) is a function that returns a set of retrieval target tokens Yⱼₖ of which the value in the fields in the row of a retrieval query token xᵢ in the similar token table is the circle symbol.

For example, in the example illustrated in FIG. 6, in the row of the retrieval query token “summer,” the retrieval target tokens “holiday” and “summertime” are returned by Simset (xᵢ).

The retrieval-result output unit 112 acquires the inter-sentence similarity from the inter-sentence-similarity calculation unit 111 and acquires the retrieval target sentences from the retrieval target DB 101. The retrieval-result output unit 112 sorts the retrieval target sentences in accordance with the inter-sentence similarity and outputs the sorted retrieval target sentences as the retrieval result.

Here, any method of sorting such as ascending or descending order of inter-sentence similarity may be selected for the sort.

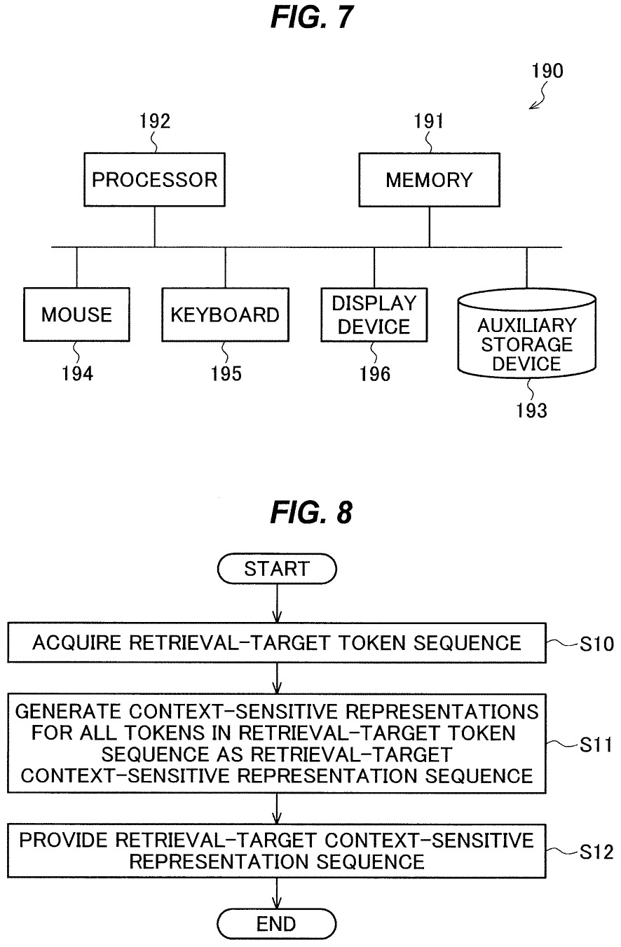

FIG. 7 is a block diagram schematically illustrating the hardware configuration implementing the document retrieval apparatus 100.

As illustrated in FIG. 7, the document retrieval apparatus 100 can be implemented by a computer 190 including a memory 191, a processor 192, an auxiliary storage device 193, a mouse 194, a keyboard 195, and a display device 196.

Specifically, a portion or the entirety of the retrieval-target context-sensitive representation generating unit 102, the data structure converting unit 104, the tokenizer 107, the retrieval-query context-sensitive representation generating unit 108, the similar-token-table generating unit 109, the inter-sentence-similarity calculation unit 111, and the retrieval-result output unit 112 described above can be implemented by the memory 191 and the processor 192, such as a central processing unit (CPU), that executes the programs stored in the memory 191. Such programs may be provided via a network or may be recorded and provided on a recording medium. That is, such programs may be provided as, for example, program products.

The retrieval target DB 101, the search DB 105, and the similar-token-table storage unit 110 can be implemented by the processor 192 using the auxiliary storage device 193. However, the auxiliary storage device 193 does not necessarily have to be present in the document retrieval apparatus 100, and an auxiliary storage device present in a cloud may be used via a communication interface (not illustrated). Note that the similar-token-table storage unit 110 may be implemented by the memory 191.

The retrieval-query input unit 106 can be implemented by the processor 192 using the mouse 194 and the keyboard 195 serving as input devices and the display device 196. Note that the mouse 194 and the keyboard 195 function as input units, and the display device 196 functions as a display unit.

FIG. 8 is a flowchart illustrating processing by the retrieval-target context-sensitive representation generating unit 102.

First, the retrieval-target context-sensitive representation generating unit 102 acquires a retrieval-target token sequence from the retrieval target DB 101 (step S10).

The retrieval-target context-sensitive representation generating unit 102 then identifies the meanings of all retrieval target tokens included in the acquired retrieval-target context-sensitive representation sequence depending on context, and arrays retrieval-target context-sensitive representations (i.e., retrieval target vectors) indicating the identified meanings in accordance with the acquired retrieval-target token sequence, to generate a retrieval-target context-sensitive representation sequence (step S11).

The retrieval-target context-sensitive representation generating unit 102 then provides the generated retrieval-target context-sensitive representation sequence to the data structure converting unit 104 and the inter-sentence-similarity calculation unit 111 (step S12).

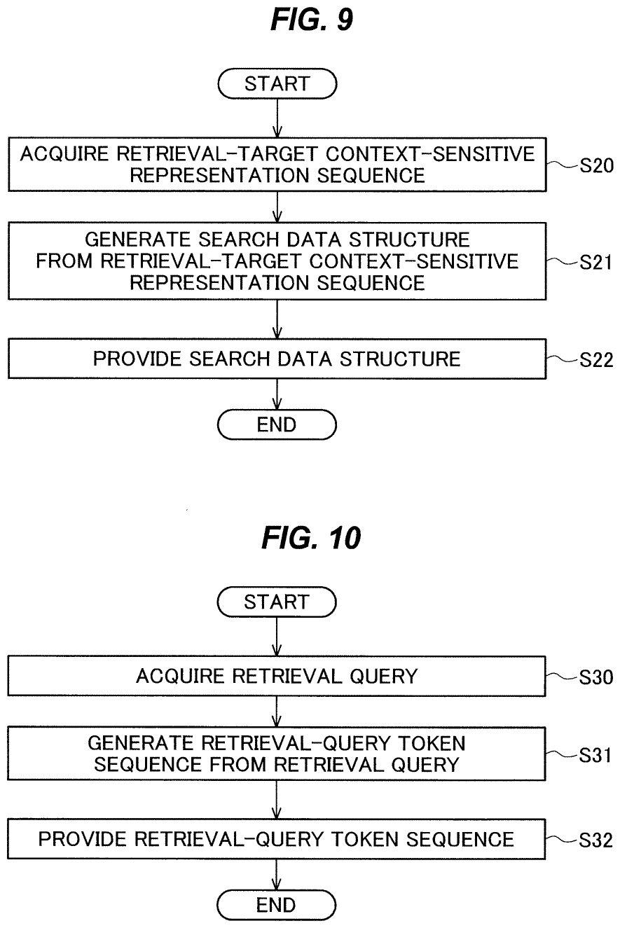

FIG. 9 is a flowchart illustrating processing by the data structure converting unit 104.

First, the data structure converting unit 104 acquires the retrieval-target context-sensitive representation sequence from the retrieval-target context-sensitive representation generating unit 102 (step S20).

Next, the data structure converting unit 104 converts the acquired retrieval-target context-sensitive representation sequence into a search data structure used for searching retrieval target tokens having relatively high similarity to the retrieval query tokens through a search method more efficient than a brute-force search (step S21).

The data structure converting unit 104 then provides the resulting search data structure to the search DB 105 (step S22). Note that the search DB 105 stores the provided search data structure.

FIG. 10 is a flowchart illustrating processing by the tokenizer 107.

The tokenizer 107 acquires a retrieval query from the retrieval-query input unit 106 (step S30).

The tokenizer 107 then identifies retrieval query tokens, which are the smallest units having meanings, in the acquired retrieval query, and generates a retrieval-query token sequence by arraying the identified retrieval query tokens in accordance with the retrieval query (step S31).

The tokenizer 107 then provides the generated retrieval-query token sequence to the retrieval-query context-sensitive representation generating unit 108 (step S32).

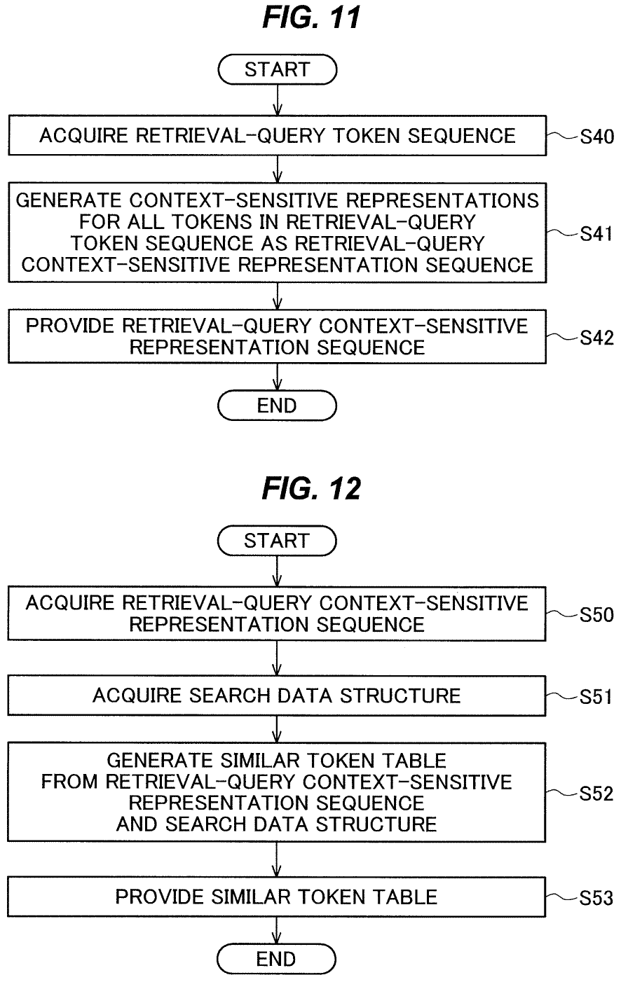

FIG. 11 is a flowchart illustrating processing by the retrieval-query context-sensitive representation generating unit 108.

First, the retrieval-query context-sensitive representation generating unit 108 acquires the retrieval-query token sequence from the tokenizer 107 (step S40).

The retrieval-query context-sensitive representation generating unit 108 then identifies the respective meanings of all retrieval target tokens included in the acquired retrieval-query context-sensitive representation sequence depending on context, and arrays context-sensitive representations indicating the identified meanings (hereinafter, also referred to as retrieval-query context-sensitive representations), or vectors (hereinafter, also referred to as retrieval query vectors) in accordance with the acquired retrieval-query token sequence, to generate a retrieval-query context-sensitive representation sequence (step S41).

The retrieval-query context-sensitive representation generating unit 108 then provides the generated retrieval-query context-sensitive representation sequence to the similar-token-table generating unit 109 and the inter-sentence-similarity calculation unit 111 (step S42).

FIG. 12 is a flowchart illustrating processing by the similar-token-table generating unit 109.

First, the similar-token-table generating unit 109 acquires the retrieval-query context-sensitive representation sequence from the retrieval-query context-sensitive representation generating unit 108 (step S50).

The similar-token-table generating unit 109 also acquires the search data structure from the search DB 105 (step S51).

The similar-token-table generating unit 109 then searches all of the retrieval-target context-sensitive representations for retrieval-target context-sensitive representations having relatively higher similarity to all of the retrieval-query context-sensitive representations included in the retrieval-query context-sensitive representation sequence by using a search method more efficient than a brute-force search in the search data structure, to generate a similar token table indicating whether the similarity between each of the retrieval-query context-sensitive representations and each of the retrieval-target context-sensitive representations is high or low (step S52).

The similar-token-table generating unit 109 then provides the generated similar token table to the similar-token-table storage unit 110 to store the similar token table in the similar-token-table storage unit 110 (step S53).

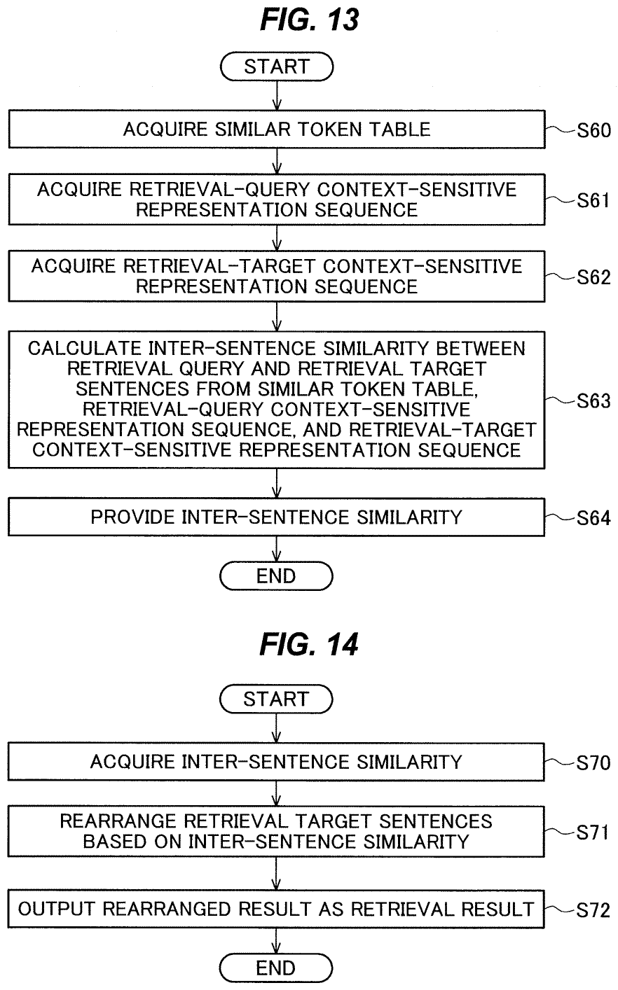

FIG. 13 is a flowchart illustrating processing by the inter-sentence-similarity calculation unit 111.

First, the inter-sentence-similarity calculation unit 111 acquires the similar token table from the similar-token-table storage unit 110 (step S60).

The inter-sentence-similarity calculation unit 111 also acquires the retrieval-query context-sensitive representation sequence from the retrieval-query context-sensitive representation generating unit 108 (step S61).

The inter-sentence-similarity calculation unit 111 also acquires the retrieval-target context-sensitive representation sequence from the retrieval-target context-sensitive representation generating unit 102 (step S62).

The inter-sentence-similarity calculation unit 111 then refers to the similar token table to calculate the inter-token similarity for the combinations of the retrieval query tokens and retrieval target tokens that are determined to have high similarity and to set the combinations determined to have low similarity to be a predetermined value (e.g., zero), and thereby calculates the inter-token similarity between the retrieval target sentences and the retrieval query (step S63).

The inter-sentence-similarity calculation unit 111 then provides the calculated inter-sentence similarity to the retrieval-result output unit 112 (step S64).

FIG. 14 is a flowchart illustrating processing by the retrieval-result output unit 112.

First, the retrieval-result output unit 112 acquires the inter-sentence similarity from the inter-sentence-similarity calculation unit 111 (step S70).

The retrieval-result output unit 112 then rearranges the retrieval target sentences in accordance with the acquired inter-sentence similarity to generate a retrieval result that can identify at least the retrieval target sentence having the highest inter-sentence similarity (step S71). Note that the retrieval-result output unit 112 may acquire the retrieval target sentences from the retrieval target DB 101.

The retrieval-result output unit 112 then displays the generated retrieval result on, for example, the display device 196 illustrated in FIG. 7, to output the retrieval result (step S72).

As described in the first embodiment above, since the inter-token similarity between tokens determined not to have high similarity can be set to a predetermined value when the inter-sentence similarity is calculated, the calculation load of the inter-sentence similarity can be reduced.

### Second Embodiment

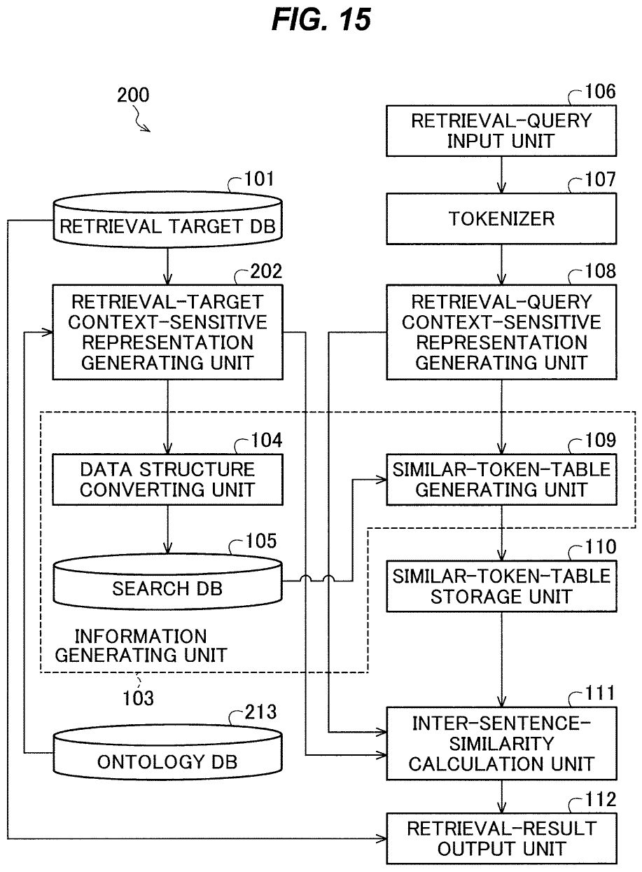

FIG. 15 is a block diagram schematically illustrating the configuration of a document retrieval apparatus 200, or an information processing apparatus according to the second embodiment.

The document retrieval apparatus 200 includes a retrieval target DB 101, a retrieval-target context-sensitive representation generating unit 202, an information generating unit 103, a retrieval-query input unit 106, a tokenizer 107, a retrieval-query context-sensitive representation generating unit 108, a similar-token-table storage unit 110, an inter-sentence-similarity calculation unit 111, a retrieval-result output unit 112, and an ontology DB 213.

The retrieval target DB 101, the information generating unit 103, the retrieval-query input unit 106, the tokenizer 107, the retrieval-query context-sensitive representation generating unit 108, the similar-token-table generating unit 109, the similar-token-table storage unit 110, the inter-sentence-similarity calculation unit 111, and the retrieval-result output unit 112 according to the second embodiment are respectively the same as the retrieval target DB 101, the information generating unit 103, the retrieval-query input unit 106, the tokenizer 107, the retrieval-query context-sensitive representation generating unit 108, the similar-token-table generating unit 109, the similar-token-table storage unit 110, the inter-sentence-similarity calculation unit 111, and the retrieval-result output unit 112 according to the first embodiment.

The ontology DB 213 is a semantic-relation-information storage unit that stores ontology, or semantic relation information indicating the semantic relation of tokens. In the second embodiment, the ontology indicates at least one of the synonymous relation and the inclusive relation of tokens as a semantic relation.

Note that the ontology DB 213 can be implemented by, for example, the processor 192 illustrated in FIG. 7 using the auxiliary storage device 193.

The retrieval-target context-sensitive representation generating unit 202 acquires a retrieval-target token sequence from the retrieval target DB 101. The retrieval-target context-sensitive representation generating unit 202 then refers to the ontology stored in the ontology DB 213, to group the retrieval target tokens included in the acquired retrieval-target token sequence into a group that can be treated as to have the same meaning. For example, the retrieval-target context-sensitive representation generating unit 202 groups into one group the retrieval target tokens that are indicated by the ontology to have a synonymous relation or an inclusive relation. Specifically, the retrieval-target context-sensitive representation generating unit 202 groups “vacation” and “holiday” into one group because they both mean “a leave of absence,” in other words, they have a synonymous relation.

The retrieval-target context-sensitive representation generating unit 202 then assigns one retrieval-target context-sensitive representation to one group to generate a retrieval-target context-sensitive representation sequence. In other words, the retrieval-target context-sensitive representation generating unit 202 generates retrieval target vectors that are the same retrieval-target context-sensitive representations from the retrieval target tokens having identified meanings that are in a synonymous relation or an inclusive relation. For example, the retrieval-target context-sensitive representation generating unit 202 may set the retrieval-target context-sensitive representation of any one of the retrieval target tokens included in one group to be the retrieval-target context-sensitive representation of the group, or may set a representative value (e.g., the average value) of the retrieval-target context-sensitive representation of a retrieval target token included in one group to be the retrieval-target context-sensitive representation of the group.

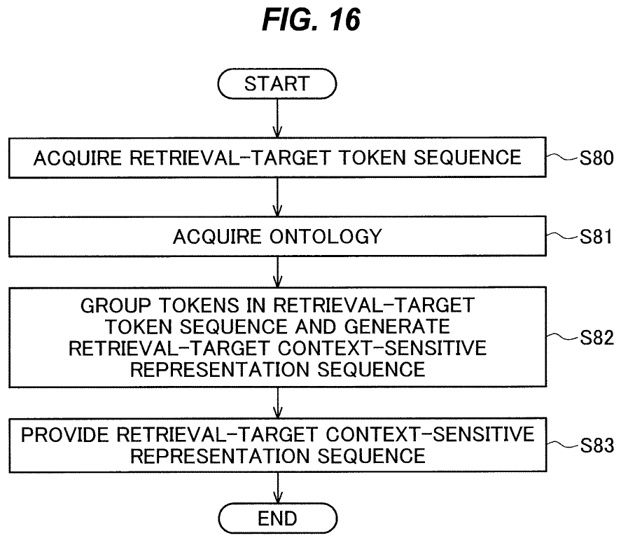

FIG. 16 is a flowchart illustrating processing by the retrieval-target context-sensitive representation generating unit 202 according to the second embodiment.

First, the retrieval-target context-sensitive representation generating unit 202 acquires a retrieval-target token sequence from the retrieval target DB 101 (step S80).

The retrieval-target context-sensitive representation generating unit 202 also acquires ontology from the ontology DB 213 (step S81).

The retrieval-target context-sensitive representation generating unit 202 then identifies the meanings of all retrieval target tokens included in the acquired retrieval-target context-sensitive representation sequence in accordance with context, refers to the acquired ontology to group the retrieval target tokens by the identified meanings, assigns one retrieval-target context-sensitive representation to the retrieval target tokens belonging to the group, and assigns retrieval-target context-sensitive representations corresponding to the identified meanings to the retrieval target tokens not belonging to the group, to generate a retrieval-target context-sensitive representation sequence (step S82).

The retrieval-target context-sensitive representation generating unit 202 then provides the generated retrieval-target context-sensitive representation sequence to the data structure converting unit 104 and the inter-sentence-similarity calculation unit 111 (step S83).

As described above, according to the second embodiment, the grouping of the retrieval target tokens reduces the number of targets to be determined whether the similarity between the retrieval query tokens and the retrieval target tokens is high by the similar-token-table generating unit 109, and thereby the processing load on the similar-token-table generating unit 109 can be reduced.

### Third Embodiment

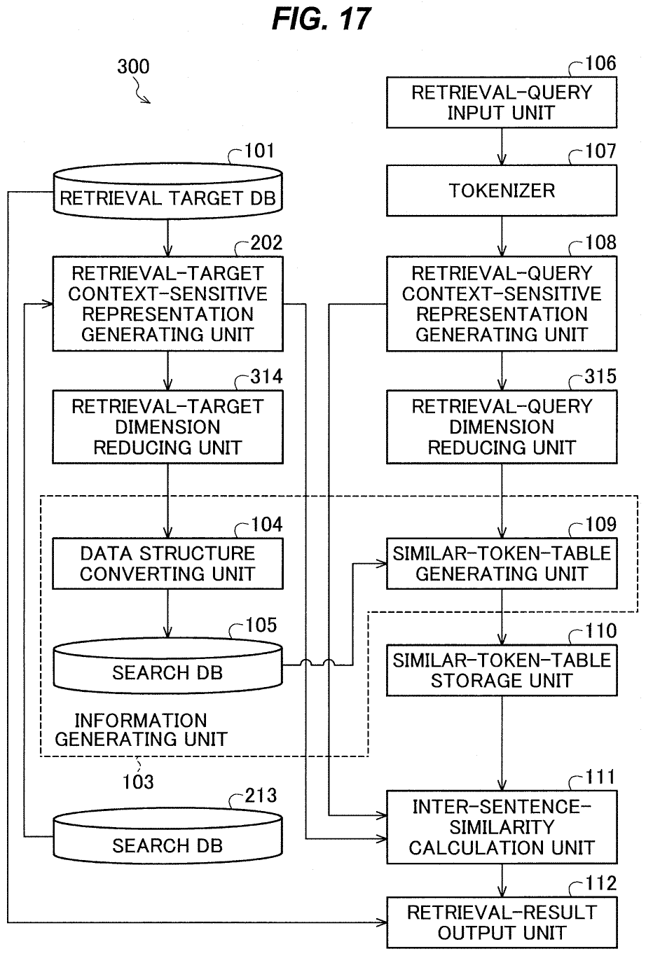

FIG. 17 is a block diagram schematically illustrating the configuration of a document retrieval apparatus 300, or an information processing apparatus according to a third embodiment.

The document retrieval apparatus 300 includes a retrieval target DB 101, a retrieval-target context-sensitive representation generating unit 202, an information generating unit 103, a retrieval-query input unit 106, a tokenizer 107, a retrieval-query context-sensitive representation generating unit 108, a similar-token-table storage unit 110, an inter-sentence-similarity calculation unit 111, a retrieval-result output unit 112, an ontology DB 213, a retrieval-target dimension reducing unit 314, and a retrieval-query dimension reducing unit 315.

The retrieval target DB 101, the information generating unit 103, the retrieval-query input unit 106, the tokenizer 107, the retrieval-query context-sensitive representation generating unit 108, the similar-token-table generating unit 109, the similar-token-table storage unit 110, the inter-sentence-similarity calculation unit 111, and the retrieval-result output unit 112 according to the third embodiment are respectively the same as the retrieval target DB 101, the information generating unit 103, the retrieval-query input unit 106, the tokenizer 107, the retrieval-query context-sensitive representation generating unit 108, the similar-token-table generating unit 109, the similar-token-table storage unit 110, the inter-sentence-similarity calculation unit 111, and the retrieval-result output unit 112 according to the first embodiment.

However, the retrieval-query context-sensitive representation generating unit 108 according to the third embodiment provides a retrieval-query context-sensitive representation sequence to the retrieval-query dimension reducing unit 315 and the inter-sentence-similarity calculation unit 111.

The retrieval-target context-sensitive representation generating unit 202 and the ontology DB 213 according to the third embodiment are respectively the same as the retrieval-target context-sensitive representation generating unit 202 and the ontology DB 213 according to the second embodiment.

However, the retrieval-target context-sensitive representation generating unit 202 according to the third embodiment provides a retrieval-target context-sensitive representation sequence to the retrieval-target dimension reducing unit 314 and the inter-sentence-similarity calculation unit 111.

The retrieval-target dimension reducing unit 314 acquires a retrieval-target context-sensitive representation sequence from the retrieval-target context-sensitive representation generating unit 202. The retrieval-target dimension reducing unit 314 performs dimension compression of all retrieval-target context-sensitive representations included in the acquired retrieval-target context-sensitive representation sequence to generate low-dimensional retrieval-target context-sensitive representations having reduced dimensions (i.e., low-dimensional retrieval target vectors), and arranges the low-dimensional retrieval-target context-sensitive representations to generate a low-dimensional retrieval-target context-sensitive representation sequence having reduced dimensions. The retrieval-target dimension reducing unit 314 provides the generated low-dimensional retrieval-target context-sensitive representation sequence to the data structure converting unit 104. Note that any known technique such as principal component analysis may be used for dimension compression.

Note that the data structure converting unit 104 according to the third embodiment converts the low-dimensional retrieval-target context-sensitive representation sequence into a search data structure. The method of conversion is the same as that in the first embodiment.

The retrieval-query dimension reducing unit 315 acquires a retrieval-query context-sensitive representation sequence from the retrieval-query context-sensitive representation generating unit 108. The retrieval-query dimension reducing unit 315 is a retrieval dimension reduction unit that performs dimension compression of all retrieval-query context-sensitive representations included in the acquired retrieval-query context-sensitive representation sequence to generate low-dimensional retrieval-query context-sensitive representations having reduced dimensions (i.e., low-dimensional retrieval vectors), and arranges the low-dimensional retrieval-query context-sensitive representations to generate a low-dimensional retrieval-query context-sensitive representation sequence having reduced dimensions. The retrieval-query dimension reducing unit 315 provides the generated low-dimensional retrieval-query context-sensitive representation sequence to the similar-token-table generating unit 109. Note that any known technique such as principal component analysis may be used for dimension compression.

Note that the similar-token-table generating unit 109 generates a similar token table by using the low-dimensional retrieval-query context-sensitive representation sequence acquired from the retrieval-query dimension reducing unit 315 and the search data structure acquired from the search DB 105. The generation method is the same as that in the first embodiment.

As described above, in the third embodiment, the information generating unit 103 generates a similar token table by using the low-dimensional retrieval-target context-sensitive representation sequence generated by the retrieval-target dimension reducing unit 314 and the low-dimensional retrieval-query context-sensitive representation sequence.

Specifically, the information generating unit 103 searches the multiple points indicated by multiple retrieval target vectors for at least one neighboring point, or at least one point located in the vicinity of a point indicated by one low-dimensional retrieval vector of multiple low-dimensional retrieval vectors, determines that the at least one combination of the retrieval token corresponding to the point indicated by the one low-dimensional retrieval vector and the at least one retrieval target token corresponding to the at least one neighboring point has high similarity, and determines that the at least one combination of the one retrieval token and the at least one retrieval target token corresponding to the at least one point other than the at least one neighboring point has low similarity, to generate a similar token table. Here, the information generating unit 103 searches for at least one neighboring point by using a search method more efficient than a brute-force search for calculating all distances between the point corresponding to one low-dimensional retrieval vector and multiple points corresponding to multiple low-dimensional retrieval target vectors.

A portion or the entirety of the retrieval-target dimension reducing unit 314 and the retrieval-query dimension reducing unit 315 described above can be implemented by the memory 191 and the processor 192 that executes the programs stored in the memory 191, as illustrated in FIG. 7.

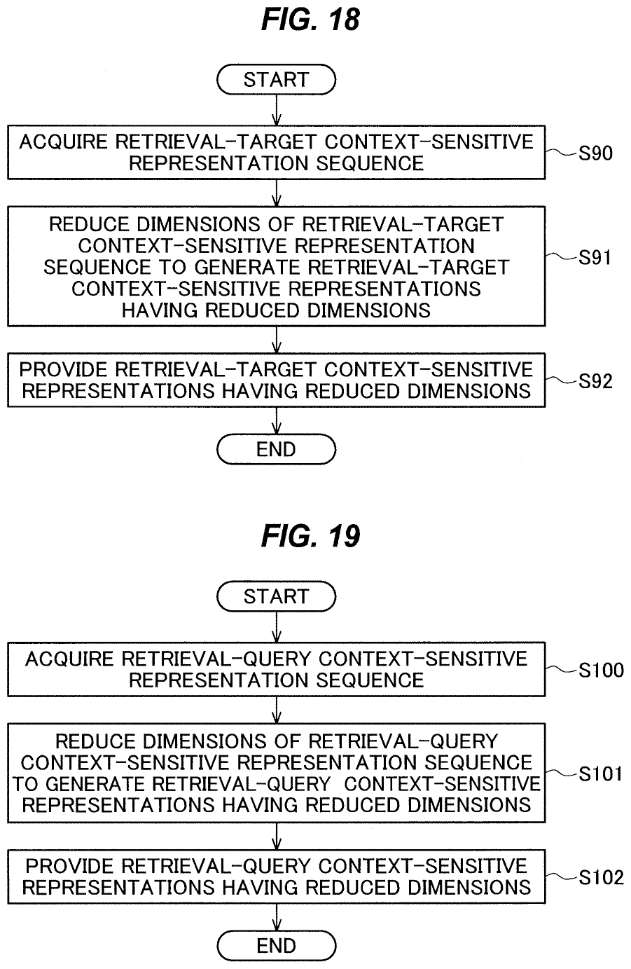

FIG. 18 is a flowchart illustrating processing by the retrieval-target dimension reducing unit 314.

First, the retrieval-target dimension reducing unit 314 acquires a retrieval-target context-sensitive representation sequence from the retrieval-target context-sensitive representation generating unit 202 (step S90).

The retrieval-target dimension reducing unit 314 then reduces the dimensions of all retrieval-target context-sensitive representations included in the acquired retrieval-target context-sensitive representation sequence to generate a low-dimensional retrieval-target context-sensitive representation sequence (step S91).

The retrieval-target dimension reducing unit 314 then provides the low-dimensional retrieval-target context-sensitive representation sequence to the data structure converting unit 104 (step S92).

FIG. 19 is a flowchart illustrating processing by the retrieval-query dimension reducing unit 315.

First, the retrieval-query dimension reducing unit 315 acquires a retrieval-query context-sensitive representation sequence from the retrieval-query context-sensitive representation generating unit 108 (step S100).

The retrieval-query dimension reducing unit 315 then reduces the dimensions of all retrieval-query context-sensitive representations included in the acquired retrieval-query context-sensitive representation sequence to generate a low-dimensional retrieval-query context-sensitive representation sequence (step S101).

The retrieval-query dimension reducing unit 315 then provides the low-dimensional retrieval-query context-sensitive representation sequence to the similar-token-table generating unit 109 (step S102).

As described above, in the third embodiment, even when the retrieval-target context-sensitive representations and the retrieval-query context-sensitive representations have high dimensions, the processing load on the similar-token-table generating unit 109 can be reduced by reducing these dimensions.

In the first to third embodiments described above, multiple retrieval target sentences and multiple retrieval-target token sequences corresponding to the multiple retrieval target sentences are stored in the retrieval target DB 101; however, the first to third embodiments are not limited to such an example. For example, the retrieval target DB 101 may store multiple retrieval target sentences, and the retrieval-target context-sensitive representation generating unit 102 may use a known technique to generate corresponding retrieval-target token sequences.

In the first to third embodiments described above, the tokenizer 107 generates a retrieval-query token sequence; however, the first to third embodiments are not limited to such an example. For example, the retrieval-query context-sensitive representation generating unit 108 may use a known technique to generate a retrieval-query token sequence from a retrieval query.

Furthermore, in the first to third embodiments described above, the retrieval-target context-sensitive representation generating units 102 and 202 and the retrieval-query context-sensitive representation generating unit 108 generate vectors from tokens depending on context; however, the first to third embodiments are not limited to such an example. For example, a vector having a one-to-one correspondence to a token may be generated independently from context.

Even in such a case, according to the present embodiment, the calculation load of the inter-sentence similarity can be reduced without preparing a lookup table that stores inter-token similarity, which is the similarity between tokens, in advance.

The third embodiment is the same as the second embodiment except that the retrieval-target dimension reducing unit 314 and the retrieval-query dimension reducing unit 315 are added; alternatively, these components may be added to the first embodiment.

### DESCRIPTION OF REFERENCE CHARACTERS

100, 200, 300 document retrieval apparatus; 101 retrieval target DB; 102, 202 retrieval-target context-sensitive representation generating unit; 103, 303 information generating unit; 104 data structure converting unit; 105 search DB; 106 retrieval-query input unit; 107 tokenizer; 108 retrieval-query context-sensitive representation generating unit; 109 similar-token-table generating unit; 111 inter-sentence-similarity calculation unit; 112 retrieval-result output unit; 213 ontology DB; 314 retrieval-target dimension reducing unit; 315 retrieval-query dimension reducing unit.

What is claimed is:

1. An information processing apparatus comprising:
a processor to execute a program; and
a memory to store multiple retrieval target sentences including multiple retrieval target tokens and similarity determination information indicating whether combinations of the respective retrieval target tokens and respective retrieval tokens have high similarity or low similarity, the retrieval target tokens each being a smallest unit having a meaning, the retrieval tokens each being a smallest unit having a meaning and being included in a retrieval sentence,
wherein the memory stores the program which, when executed by the processor, performs processes of
calculating inter-token similarity for the combinations indicated to have high similarity in the similarity determination information, and setting the inter-token similarity to a predetermined value for the combinations indicated to have low similarity in the similarity determination information, to calculate inter-sentence similarity between the retrieval sentence and the respective retrieval target sentences.

2. The information processing apparatus according to claim 1, wherein
the program which, when executed by the processor, performs processes of
generating multiple retrieval target vectors, the retrieval target vectors being vectors corresponding to the meanings of the retrieval target tokens;
generating multiple retrieval vectors, the retrieval vectors being vectors corresponding to the meanings of the retrieval tokens;
searching multiple points indicated by the retrieval target vectors for at least one neighboring point located in the vicinity of a point indicated by one retrieval vector of the retrieval vectors;
determining that at least one combination of one retrieval token corresponding to the point indicated by the one retrieval vector and at least one retrieval target token corresponding to the at least one neighboring point has high similarity and at least one combination of the one retrieval token and at least one retrieval target token corresponding to at least one point other than the at least one neighboring point has low similarity, to generate the similarity determination information; and
searching for the at least one neighboring point by using a search method more efficient than a brute-force search of calculating all distances between the point corresponding to the one retrieval vector and multiple points corresponding to the multiple retrieval target vectors.

3. The information processing apparatus according to claim 1, wherein
the program which, when executed by the processor, performs processes of
generating multiple retrieval target vectors, the retrieval target vectors being vectors corresponding to the meanings of the retrieval target tokens; and
reducing dimensions of the retrieval target vectors to generate multiple low-dimensional retrieval target vectors;
generating multiple retrieval vectors, the retrieval vectors being vectors corresponding to the meanings of the retrieval tokens;
reducing dimensions of the retrieval vectors to generate multiple low-dimensional retrieval vectors;
searching multiple points indicated by the multiple low-dimensional retrieval target vectors for at least one neighboring point located in the vicinity of a point indicated by one low-dimensional retrieval vector of the low-dimensional retrieval vectors;
determining that at least one combination of one retrieval token corresponding to the point indicated by the one low-dimensional retrieval vector and at least one retrieval target token corresponding to the at least one neighboring point has high similarity and at least one combination of the one retrieval token and at least one retrieval target token corresponding to at least one point other than the at least one neighboring point has low similarity, to generate the similarity determination information; and
searching for the at least one neighboring point by using a search method more efficient than a brute-force search of calculating all distances between the point corresponding to the one low-dimensional retrieval vector and multiple points corresponding to the multiple low-dimensional retrieval target vectors.

4. The information processing apparatus according to claim 2,
wherein the program which, when executed by the processor, performs a process of searching for the at least one neighboring point through k-approximate nearest neighbor search for searching k neighboring points, where k is an integer of one or more.

5. The information processing apparatus according to claim 3,
wherein the program which, when executed by the processor, performs a process of searching for the at least one neighboring point through k-approximate nearest neighbor search for searching k neighboring points, where k is an integer of one or more.

6. The information processing apparatus according to claim 2, wherein the program which, when executed by the processor, performs processes of,
identifying the meanings of the retrieval target tokens depending on context of the retrieval target sentences and generates the retrieval target vectors, and
identifying the meanings of the retrieval tokens depending on context of the retrieval sentence and generates the retrieval vectors.

7. The information processing apparatus according to claim 3, wherein the program which, when executed by the processor, performs processes of,
identifying the meanings of the retrieval target tokens depending on context of the retrieval target sentences and generates the retrieval target vectors, and
identifying the meanings of the retrieval tokens depending on context of the retrieval sentence and generates the retrieval vectors.

8. The information processing apparatus according to claim 4, wherein the program which, when executed by the processor, performs processes of,
identifying the meanings of the retrieval target tokens depending on context of the retrieval target sentences and generates the retrieval target vectors, and
identifying the meanings of the retrieval tokens depending on context of the retrieval sentence and generates the retrieval vectors.

9. The information processing apparatus according to claim 5, wherein the program which, when executed by the processor, performs processes of,
identifying the meanings of the retrieval target tokens depending on context of the retrieval target sentences and generates the retrieval target vectors, and
identifying the meanings of the retrieval tokens depending on context of the retrieval sentence and generates the retrieval vectors.

10. The information processing apparatus according to claim 6,
wherein the program which, when executed by the processor, performs a process of generating same retrieval target vectors from the retrieval target tokens, the identified meanings of the retrieval target tokens having a synonymous relation or an inclusive relation.

11. The information processing apparatus according to claim 7,
wherein the program which, when executed by the processor, performs a process of generating same retrieval target vectors from the retrieval target tokens, the identified meanings of the retrieval target tokens having a synonymous relation or an inclusive relation.

12. The information processing apparatus according to claim 8,
wherein the program which, when executed by the processor, performs a process of generating same retrieval target vectors from the retrieval target tokens, the identified meanings of the retrieval target tokens having a synonymous relation or an inclusive relation.

13. The information processing apparatus according to claim 9,
wherein the program which, when executed by the processor, performs a process of generating same retrieval target vectors from the retrieval target tokens, the identified meanings of the retrieval target tokens having a synonymous relation or an inclusive relation.

14. The information processing apparatus according to claim 1, wherein the program which, when executed by the processor, performs processes of
generating multiple retrieval target vectors, the retrieval target vectors being vectors corresponding to the meanings of the retrieval target tokens;
generating multiple retrieval vectors, the retrieval vectors being vectors corresponding to the meanings of the retrieval tokens; and
when the inter-token similarity is calculated, making the inter-token similarity of the combination of one retrieval target vector of the retrieval target vectors and one retrieval vector of the retrieval vectors higher as the distance becomes smaller between a point indicated by the one retrieval target vector and a point indicated by the one retrieval vector.

15. The information processing apparatus according to claim 1,
wherein the program which, when executed by the processor, performs a process of identifying maximum values of the inter-token similarity in combinations of the retrieval tokens and the retrieval target tokens included in one of the retrieval target sentences and averaging the identified maximum values, to calculate the inter-sentence similarity between the retrieval sentence and the one retrieval target sentence.

16. A non-transitory computer-readable storage medium storing a program that causes a computer to execute processes of,
storing multiple retrieval target sentences including multiple retrieval target tokens, the retrieval target tokens each being a smallest unit having a meaning;
storing similarity determination information indicating whether combinations of the respective retrieval target tokens and respective retrieval tokens have high similarity or low similarity, the retrieval tokens each being a smallest unit having a meaning and being included in a retrieval sentence;
calculating inter-token similarity for the combinations indicated to have high similarity in the similarity determination information, and setting the inter-token similarity to a predetermined value for the combinations indicated to have low similarity in the similarity determination information, to calculate inter-sentence similarity between the retrieval sentence and the respective retrieval target sentences.

17. An information processing method comprising:
calculating inter-sentence similarities between multiple retrieval target sentences including multiple retrieval target tokens and a retrieval sentence including multiple retrieval tokens, the retrieval target tokens each being a smallest unit having a meaning, the retrieval tokens each being a smallest unit having a meaning;
accepting input of the retrieval sentence; and
calculating inter-token similarity for combinations indicated to have high similarity in the similarity determination information indicating whether the combinations of the retrieval target tokens and the retrieval tokens have high similarity or low similarity, and setting the inter-token similarity to a predetermined value for the combinations indicated to have low similarity in the similarity determination information, to calculate the inter-sentence similarities between the retrieval sentence and the respective retrieval target sentences.
